(19) United States
(12) Patent Application Publication
(10) Pub. No.: US 2015/0268493 A1
(43) Pub. Date: Sep. 24, 2015

(54) LIQUID CRYSTAL DISPLAY DEVICE AND MANUFACTURING METHOD THEREOF

(71) Applicant: SAMSUNG DISPLAY CO., LTD., Yongin-City (KR)

(72) Inventor: Sung Hwan HONG, Suwon-si (KR)

(21) Appl. No.: 14/485,925

(22) Filed: Sep. 15, 2014

(30) Foreign Application Priority Data
Mar. 18, 2014 (KR) 10-2014-0031846

(51) Int. Cl. G02F 1/1337

(52) U.S. Cl. CPC G02F 1/1337

(57) ABSTRACT

A liquid crystal display device includes a first substrate, a second substrate facing the first substrate, a pair of field generating electrodes respectively disposed on the first substrate and the second substrate, an alignment pattern disposed on an inner side of any one of the first substrate and the second substrate, and a liquid crystal layer disposed between the first substrate and the second substrate and including a liquid crystal disposed in a spiral structure in which chiral nematic liquid crystal molecules are repetitively twisted at a predetermined pitch with reference to a spiral axis which is vertical to a progress direction of light in a voltage-off state, where the alignment pattern is defined in a protruding shape to correspond to the predetermined pitch.

This application claims priority to Korean Patent Application No. 10-2014-0031846, filed on Mar. 18, 2014, and all the benefits accruing therefrom under 35 U.S.C. §119, the entire contents of which are incorporated herein by reference.

### BACKGROUND

(a) Field

The invention relates to a liquid crystal display (“LCD”) and a manufacturing method thereof, and more particularly, to a uniformly lying helix (“ULH”) mode LCD device to be driven by a low voltage and a manufacturing method thereof

(b) Description of the Related Art

Recently, with the progression of an information age, a display field has been rapidly developed, and accordingly, as flat panel display (“FPD”) devices having advantages of reduction in thickness and weight, and low power consumption, a liquid crystal display (“LCD”) device, a plasma display panel (“PDP”) device, an electroluminescence display (“ELD”) device, a field emission display (“FED”) device, and the like are introduced, and in the limelight by rapidly replacing an existing cathode ray tube (“CRT”).

Among the flat panel display devices, the LCD device has been most actively used in various fields such as a notebook, a monitor, a television (“TV”), and the like due to excellent motion-picture display and a high contrast ratio.

A liquid crystal used in the LCD includes a nematic liquid crystal, a smectic liquid crystal, a cholesteric liquid crystal, and the like, and the nematic liquid crystal is mainly used.

In the LCD device, deterioration of image quality by an afterimage and the like due to a low response speed are involved.

Accordingly, recently, research of an LCD device having a high response speed has been actively conducted, and as a result, an LCD device including a uniformly lying helix (“ULH”) mode liquid crystal has been proposed, and the ULH mode liquid crystal has a very fast response speed because a bimesogen liquid crystal is arranged in a structure having polarity. Accordingly, the response speed of the LCD device may be improved.

### SUMMARY

The invention has been made in an effort to provide a liquid crystal display (“LCD”) device and a manufacturing method thereof having advantages of simply manufacturing and stabilizing alignment of a uniformly lying helix (“ULH”) mode liquid crystal without a separate process by using an alignment pattern instead of an alignment layer.

An exemplary embodiment of the invention provides an LCD device including a first substrate, a second substrate facing the first substrate, a pair of field generating electrodes formed on the first substrate and the second substrate, an alignment pattern formed on an inner side of any one of the first substrate and the second substrate, and a liquid crystal layer disposed between the first substrate and the second substrate and including a liquid crystal disposed in a spiral structure in which chiral nematic liquid crystal molecules are repetitively twisted at a predetermined pitch based on a spiral axis which is vertical to a progress direction of light in a voltage-off state, in which the alignment pattern is formed in a protruding shape to correspond to the predetermined pitch.

In an exemplary embodiment, the liquid crystal may be optically isotropic in a voltage-off state, and birefringence may be generated in a voltage applying direction in a voltage-on state.

In an exemplary embodiment, a plurality of alignment patterns may be provided, and an alignment groove may be defined between the plurality of alignment patterns.

In an exemplary embodiment, the alignment pattern may include silicon oxide (SiOx) or silicon nitride (SiNx).

In an exemplary embodiment, a distance between the adjacent alignment patterns may be formed to correspond to a multiple of the predetermined pitch of the liquid crystal disposed in the spiral structure.

In an exemplary embodiment, the alignment pattern may correspond to a portion where the liquid crystal is arranged in a vertical direction to the sides of the first substrate and the second substrate.

In an exemplary embodiment, a distance between the adjacent alignment patterns may be about 200 nanometers (nm) to about 4,000 nm.

In an exemplary embodiment, a distance between the adjacent alignment patterns may be formed to be the same as one pitch of the liquid crystal disposed in the spiral structure.

In an exemplary embodiment, a distance between the adjacent alignment patterns may be about 200 nm to about 300 nm.

In an exemplary embodiment, the alignment pattern may be disposed on all of inner sides of the first substrate and the second substrate.

In an exemplary embodiment, the alignment pattern disposed on the inner sides of the first substrate and the second substrate may be formed at a corresponding position.

Another exemplary embodiment of the invention provides a manufacturing method of an LCD including forming a pixel electrode on a first substrate, sequentially depositing an organic layer and a photoresist on the first substrate formed with the pixel electrode, forming a pattern defined in a straight line by exposing and developing the organic layer and the photoresist, forming a pattern layer on the entire surface of the first substrate including an upper portion of the patterns of the organic layers and the photoresists and grooves defined between the patterns, forming an alignment pattern and an alignment groove which protrude from the first substrate by etching portions corresponding to the pattern of the organic layer and the photoresist in the pattern layer, forming a common electrode on a second substrate facing the first substrate, and injecting a liquid crystal disposed in a spiral structure in which chiral nematic liquid crystal molecules are repetitively twisted at a predetermined pitch based on a spiral axis which is vertical to a progress direction of light in a voltage-off state, between the first substrate and the second substrate.

According to the exemplary embodiment of the invention, it is possible to simply manufacture and stabilize alignment of a ULH mode liquid crystal without a separate process by using an alignment pattern instead of an alignment layer.

Further, liquid crystal heat stability through uniform arrangement of the liquid crystal is excellent.

### BRIEF DESCRIPTION OF THE DRAWINGS

The above and other exemplary embodiments, advantages and features of this disclosure will become more apparent by describing in further detail exemplary embodiments thereof with reference to the accompanying drawings, in which:

FIG. 1 is a plan view of a liquid crystal display (“LCD”) device according to an exemplary embodiment of the invention.

FIG. 2 is a cross-sectional view of the LCD device of FIG. 1 taken along line II-II.

FIG. 3 is a cross-sectional view taken along line III-III of FIG. 1.

FIG. 4 is a diagram schematically illustrating an exemplary embodiment of a driving principle of a ULH mode liquid crystal in a ULH mode LCD device according to the invention.

FIG. 5A is a side view of a liquid crystal arrangement structure, and FIG. 5B is a cross-sectional view illustrating an equivalent structure of the liquid crystal.

FIG. 6 is a cross-sectional view schematically illustrating a driving principle of the ULH mode liquid crystal.

FIG. 7 is a diagram illustrating an exemplary embodiment of an alignment pattern according to the invention.

FIGS. 8 to 12 are cross-sectional views sequentially illustrating an exemplary embodiment of a manufacturing process of an alignment pattern according to the invention.

FIG. 13 is a cross-sectional view of another exemplary embodiment of an LCD device according to the invention.

FIG. 14 is a cross-sectional view of another exemplary embodiment of the LCD device according to the invention.

### DETAILED DESCRIPTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention.

In the drawings, the thickness of layers, films, panels, regions, etc., is exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

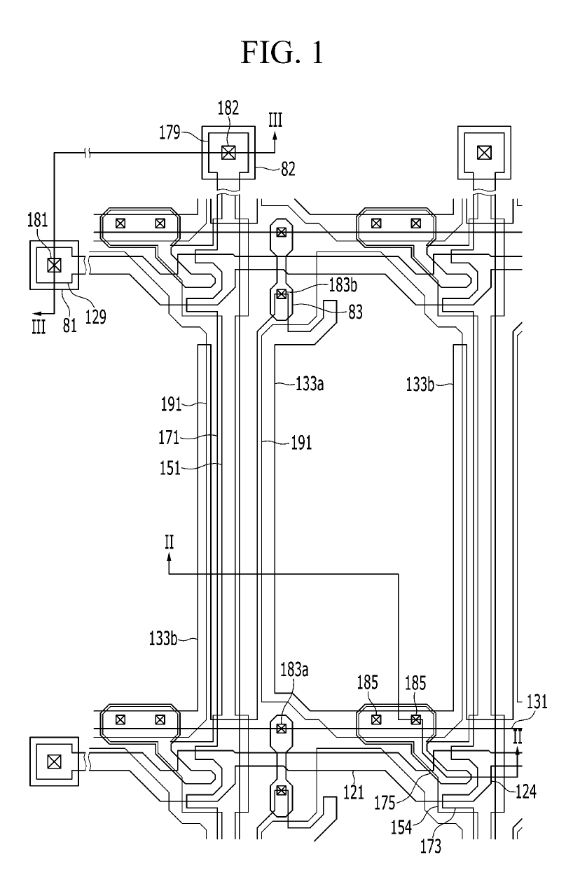

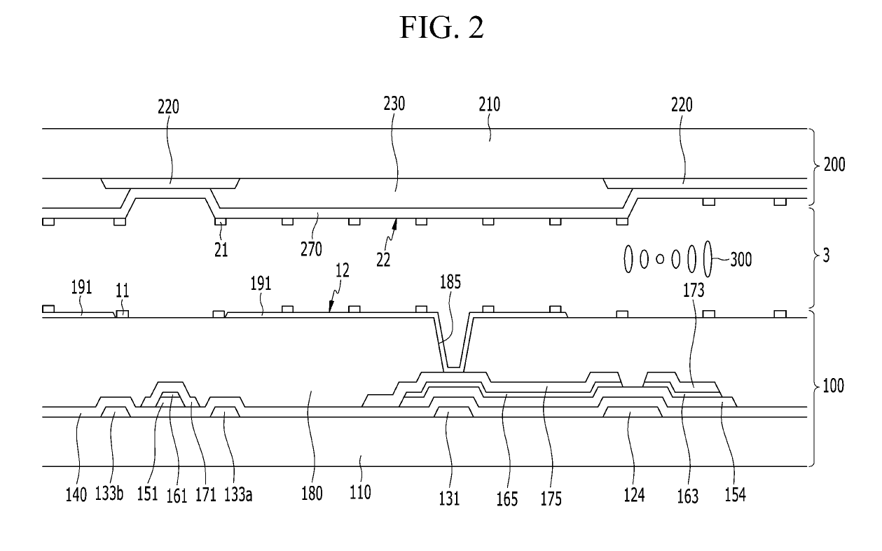

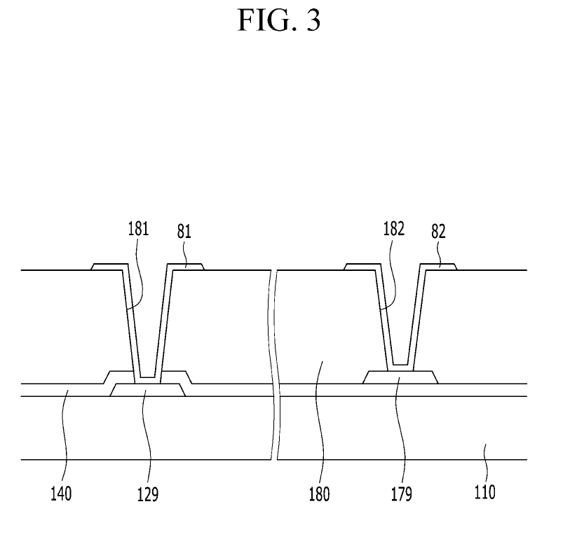

Hereinafter, a liquid crystal display (“LCD”) device according to an exemplary embodiment of the invention will be described in detail with reference to FIGS. 1 to 3.

Referring to FIGS. 1 to 3, an LCD device according to an exemplary embodiment includes a lower panel 100 and an upper panel 200 facing each other, and a liquid crystal layer 3 interposed between the two panels 100 and 200.

First, the lower panel 100 will be described.

A plurality of gate lines 121 and a plurality of storage electrode lines 131 are formed on an insulation substrate 110 (hereinafter, also referred to as a first substrate) including transparent glass, plastic, or the like.

The gate line 121 transfers a gate signal and extends in a substantially horizontal direction. Each gate line 121 includes a plurality of gate electrodes 124 protruding downward, and a wide end portion 129 for connecting with another layer or an external driving circuit. In an exemplary embodiment, a gate driving circuit (not illustrated) generating a gate signal may be installed on a flexible printed circuit film (not illustrated) attached onto the first substrate 110, installed directly on the first substrate 110, or integrated in the first substrate 110.

The storage electrode line 131 receives a predetermined voltage, and includes a stem line extending in parallel with the gate line, and a plurality of pairs of first and second storage electrodes 133a and 133b which are branched from the stem line. Each of the storage electrode lines 131 is positioned between two adjacent gate lines 121, and the stem line is close to a lower gate line of the two gate lines 121. Each of the storage electrodes 133a and 133b has a fixed end connected with the stem line and a free end which is opposite to the fixed end. The fixed end of the first storage electrode 133a has a large area, and the free end thereof is divided into two parts of a linear portion and a curved portion. However, a shape and a layout of the storage electrode line 131 may be variously modified.

In an exemplary embodiment, the gate line 121 and the storage electrode line 131 may include aluminum-based metal such as aluminum (Al) or an aluminum alloy, silver-based metal such as silver (Ag) or a silver alloy, copper-based metal such as copper (Cu) or a copper alloy, molybdenum-based metal such as molybdenum (Mo) or a molybdenum alloy, chromium (Cr), tantalum (Ta), titanium (Ti), and the like. However, in other exemplary embodiment, the gate line 121 and the storage electrode line 131 may have a multilayered structure including two conductive layers (not illustrated) having different physical properties.

Sides of the gate line 121 and the storage electrode line 131 are tilted with respect to the surface of the first substrate 110 in a cross section, and a tilt angle may be about 30 degrees (°) to about 80°, for example.

In an exemplary embodiment, a gate insulating layer 140 including silicon nitride (SiNx), silicon oxide (SiOx), or the like is disposed on the gate line 121 and the storage electrode line 131.

In an exemplary embodiment, a plurality of semiconductor stripes 151 including hydrogenated amorphous silicon (herein, amorphous silicon is written as an acronym a-Si), polysilicon, or the like is disposed on the gate insulating layer 140. The semiconductor stripe 151 extends in a substantially vertical direction, and includes a plurality of protrusions 154 protruding toward the gate electrode 124.

A plurality of ohmic contact stripes and islands 161 and 165 are disposed on the semiconductor 151. In an exemplary embodiment, the ohmic contacts 161 and 165 may include a material such as n+ hydrogenated amorphous silicon in which an n-type impurity such as phosphorus is doped at high concentration, or silicide. The ohmic contact stripe 161 has a plurality of protrusions 163, and the protrusion 163 and the ohmic contact island 165 make a pair to be disposed on the protrusion 154 of the semiconductor 151.

Sides of the semiconductor 151 and the ohmic contacts 161 and 165 are also tilted with respect to the surface of the first substrate 110 in a cross section, and tilt angles thereof may be about 30° to about 80°.

A plurality of data lines 171 and a plurality of drain electrodes 175 are disposed on the ohmic contacts 161 and 165 and the gate insulating layer 140.

The data line 171 transfers a data signal and mainly extend in a vertical direction to cross the gate line 121. Each data line 171 crosses the storage electrode line 131 to extend between a set of adjacent storage electrode 133a and 133b. Each data line 171 includes a plurality of source electrodes 173 which extends toward the gate electrode 124, and a wide end portion 179 for connecting with another layer or an external driving circuit. A data driving circuit (not illustrated) generating a data signal may be installed on a flexible printed circuit film (not illustrated) attached onto the first substrate 110, installed directly on the first substrate 110, or integrated on the first substrate 110.

The drain electrode 175 is separated from the data line 171 and faces the source electrode 173 with reference to the gate electrode 124.

One gate electrode 124, one source electrode 173, and one drain electrode 175 provide one thin film transistor (“TFT”) together with the protrusion 154 of the semiconductor 151, and a channel of the thin film transistor is positioned in the protrusion 154 between the source electrode 173 and the drain electrode 175.

In an exemplary embodiment, the data line 171 and the drain electrode 175 may include a low resistive conductor such as the gate line 121 and the storage electrode line 131.

In an exemplary embodiment, sides of the data line 171 and the drain electrode 175 may also be tilted at a tilt angle of about 30° to about 80° with respect to the surface of the first substrate 110 in a cross section.

A passivation layer 180 is positioned on the data line 171, the drain electrode 175, and an exposed portion of the semiconductor 151. In an exemplary embodiment, the passivation layer 180 includes an inorganic insulator or an organic insulator, and a surface thereof may be flat.

In the passivation layer 180, a plurality of contact holes 182 and 185 respectively exposing the end portion 179 of the data line 171 and the drain electrode 175, are defined. In the passivation layer 180 and the gate insulating layer 140, a plurality of contact holes 181 exposing the end portion 129 of the gate line 121, a plurality of contact holes 183a exposing a part of the storage electrode line 131 near the fixed end of the first storage electrode 133a, and a plurality of contact holes 183b exposing the protrusion of the free end of the first storage electrode 133a are provided.

A plurality of pixel electrodes 191, a plurality of overpasses 83, and a plurality of contact assistants 81 and 82 are disposed on the passivation layer 180. In an exemplary embodiment, the plurality of pixel electrodes 191, the plurality of overpasses 83, and the plurality of contact assistants 81 and 82 may include a transparent conductive material such as indium tin oxide (“ITO”) or indium zinc oxide (“IZO”), or reflective metal such as aluminum, silver, chromium, or an alloy thereof.

The pixel electrode 191 is physically and electrically connected with the drain electrode 175 through the contact hole 185, and receives a data voltage from the drain electrode 175. The pixel electrode 191 to which the data voltage is applied generates an electric field together with a common electrode 270 of the upper panel 200 receiving a common voltage to determine directions of the liquid crystal molecules of the liquid crystal layer 3 between the two electrodes 191 and 270. Polarization of light passing through the liquid crystal layer 3 varies according to the determined directions of the liquid crystal molecules. The pixel electrode 191 and the common electrode 270 provide a capacitor (herein, referred to as a “liquid crystal capacitor”) to maintain the applied voltage even after the thin film transistor is turned off

The pixel electrode 191 overlaps with the storage electrode line 131 including the storage electrodes 133a and 133b, the capacitor provided when the pixel electrode 191 and the drain electrode 175 electrically connected therewith overlap with the storage electrode line 131 is called a storage capacitor, and the storage capacitor reinforces voltage storage ability of the liquid crystal capacitor.

The contact assistants 81 and 82 are connected with the end portion 129 of the gate line 121 and the end portion 179 of the data line 171 through the contact holes 181 and 182, respectively. The contact assistants 81 and 82 compensate for adhesion between the end portion 129 of the gate line 121 and the end portion 179 of the data line 171 and an external device, and protect the end portion 129 of the gate line 121 and the end portion 179 of the data line 171 and the external device.

The overpass 83 traverses the gate line 121, and is connected with an exposed portion of the storage electrode line 131 and an exposed end portion of the free end of the storage electrode 133b through the contact holes 183a and 183b which are positioned to be opposite to each other with the gate line 121 therebetween. The storage electrode line 131 including the storage electrodes 133a and 133b may be used to repair a defect of the gate line 121 or the data line 171, or the thin film transistor together with the overpass 83.

Next, the upper panel 200 facing the lower panel 100 will be described.

In an exemplary embodiment, a light blocking member 220 which is called a black matrix is disposed on an insulation substrate 210 (hereinafter, referred to as a second substrate) including transparent glass, plastic, or the like. A plurality of openings which faces the pixel electrode 191 is defined in the light blocking member 220 and has substantially the same shape as the pixel electrode 191, and prevents light leakage between the pixel electrodes 191. The light blocking members 220 may be provided by a portion corresponding to the gate line 121 and the data line 171 and a portion corresponding to the thin film transistor.

A plurality of color filters 230 is disposed on the substrate 210. The color filters 230 is disposed on most of an area surrounded by the light blocking member 220, and may be elongated in any direction. In an exemplary embodiment, each color filter 230 may display one of the primary colors such as three primary colors of red, green and blue, for example.

In an exemplary embodiment, a common electrode 270 including a transparent conductor such as ITO or IZO is disposed on the color filter 230.

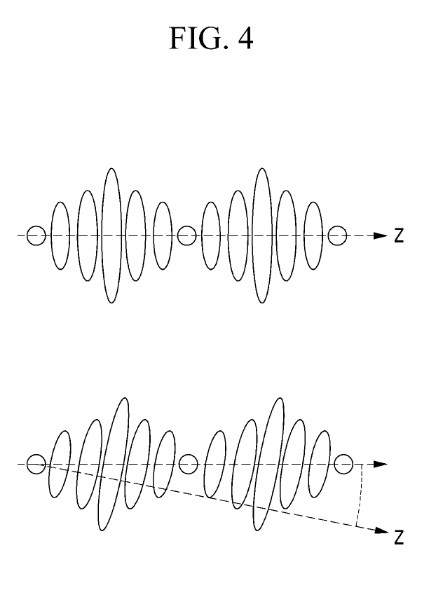

Herein, ULH mode liquid crystal molecules 300 of the liquid crystal layer 3 will be described in detail with reference to FIGS. 4 to 6.

FIG. 4 is a diagram schematically illustrating a driving principle of a uniformly lying helix (“ULH”) mode liquid crystal 300 in a ULH mode LCD device according to an exemplary embodiment of the invention.

As illustrated in FIG. 4, the ULH mode liquid crystal 300 in a voltage-off state has a spiral structure in which chiral nematic liquid crystal molecules having small pitches are twisted dozens of times, and an axis having a spiral structure, that is, a spiral axis is vertical to an optical axis.

In a voltage-on state, the optical axis of the ULH mode liquid crystal 300 is twisted, and birefringence is expressed.

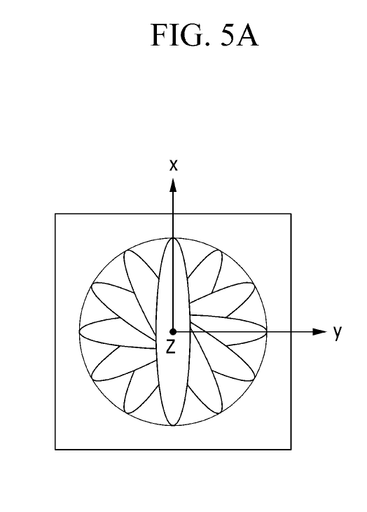

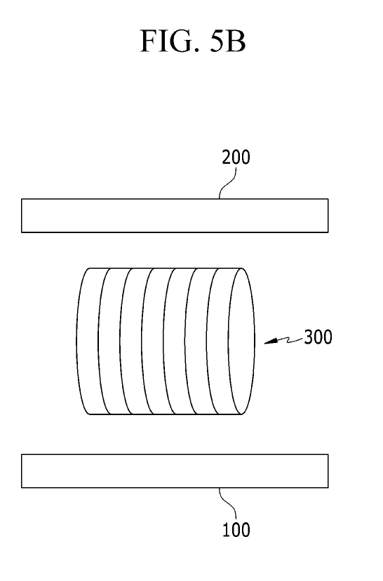

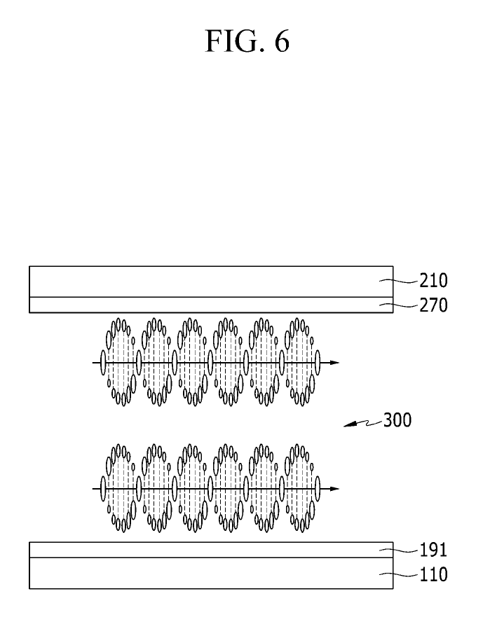

FIG. 5A is a side view of a liquid crystal arrangement structure, and FIG. 5B is a cross-sectional view illustrating an equivalent structure of the liquid crystal, and FIG. 6 is a cross-sectional view schematically illustrating a driving principle of the ULH mode liquid crystal in a general LCD device.

As illustrated in FIGS. 5A to 6, the ULH mode LCD device is configured by first and second substrates 110 and 210 facing each other, a ULH mode liquid crystal 300 positioned between the first and second substrates 110 and 210, and first and second polarizers (not illustrated) positioned outside of each of the first and second substrates 110 and 210.

The ULH mode liquid crystal 300 has a very rapid response speed because a bimesogen liquid crystal is arranged in a structure having polarity.

As described above, the ULH mode liquid crystal 300 has a spiral structure in which chiral nematic liquid crystal molecules having small pitches are twisted dozens of times, and an axis of the spiral structure, that is, a spiral axis is vertical to a progressing direction (e.g., x direction) of light.

Further, in the liquid crystal 300, a z-directional refractive index is smaller than x and y-directional refractive indexes which are vertical to the z-direction, and the x and y-directional refractive indexes are the same as each other (i.e., nz<nx=ny).

That is, at a front viewing angle, the liquid crystal 300 has an optical isotropic property, and in the voltage-off state, at the front viewing angle, it is advantageous that birefringence is not expressed and an excellent black characteristic may be obtained. Accordingly, it is advantageous in a high contrast.

Such a ULH mode liquid crystal 300 becomes optically isotropic in the voltage-off state, and birefringence is generated in a voltage applying direction by applying the voltage, and as a result, in order to control transmittance of the ULH mode liquid crystal 300 by the birefringence, first and second polarizers (not illustrated) are disposed so that polarization axes thereof are vertical to each other, and an electric field needs to be applied in a vertical direction (length direction) to the substrates 110 and 210.

Accordingly, in the ULH mode LCD device, basically, a vertical field mode electrode structure is suitable.

Referring to FIG. 6 which is a schematic cross-sectional view for describing a driving principle of the ULH mode liquid crystal 300 in the ULH mode LCD device, the first and second substrates 110 and 210 face each other, the ULH mode liquid crystal layer 300 is interposed between the first and second substrates 110 and 210, and the pixel electrode 191 on the first substrate 110 and the common electrode 270 facing the pixel electrode 191 on the second substrate 210 are arranged.

Such a ULH mode LCD device may obtain a wide viewing angle because the structure of the electrodes 191 and 270 is the vertical field mode.

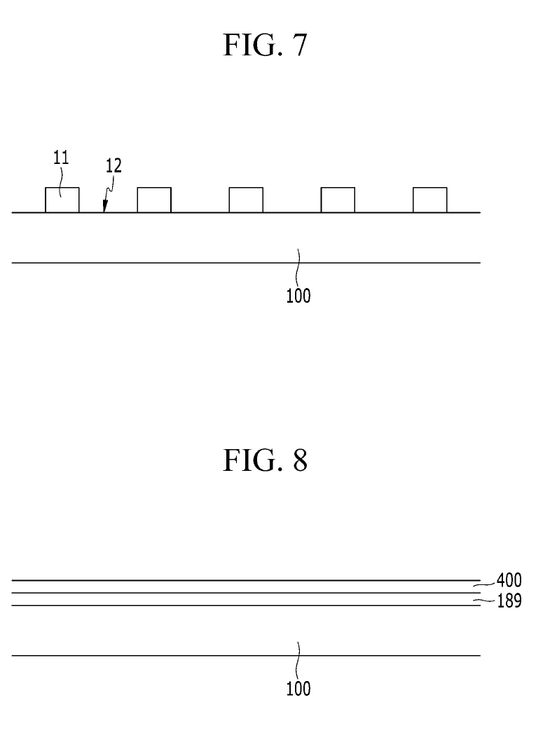

Alignment patterns 11 and 21 are disposed on inner surfaces of the display panels 100 and 200 of the LCD device according to the exemplary embodiment of the invention, as illustrated in FIG. 7.

FIG. 7 is a diagram illustrating an alignment pattern according to an exemplary embodiment of the invention.

The alignment patterns 11 and 21 have alignment grooves 12 and 22 provided at a predetermined interval, and may include silicon oxide (SiOx) or silicon nitride (SiNx).

Generally, in order to provide the ULH mode LCD device, after the ULH mode liquid crystal 300 is injected, a process of heating the ULH mode liquid crystal 300 up to an isotropic state and slowly cooling the ULH mode liquid crystal 300 in a state of applying a high voltage and a high frequency is required.

Further, in the ULH mode liquid crystal 300, vertical and horizontal alignment provides coexist at the same time, and in the alignment layer, it is difficult to provide vertical and horizontal alignment layers on one layer at the same time. As a result, the ULH mode liquid crystal 300 of the ULH mode LCD device provided through the aforementioned process may have an unstable alignment state.

Silicon oxide (SiOx) or silicon nitride (SiNx) has a property of vertically aligning the liquid crystal molecules, and by using the property, at a portion where the ULH mode liquid crystal 300 is vertically aligned, the alignment patterns 11 and 21 including silicon oxide (SiOx) or silicon nitride (SiNx) are provided to obtain an effect of the vertical alignment layer, and at a portion where the ULH mode liquid crystal 300 is horizontally aligned, the alignment grooves 12 and 22 without the alignment patterns 11 and 21 are provided to obtain an effect of the horizontal alignment layer, and as a result, the alignment state of the ULH mode liquid crystal 300 may be stably provided.

Further, the effect of the vertical alignment and the horizontal alignment of the ULH mode liquid crystal 300 is secured by the providing the alignment patterns 11 and 21 and the alignment grooves 12 and 22, and as a result, a separate process of providing the aforementioned ULH mode LCD device may be omitted.

In the spiral structure in which the chiral nematic liquid crystal molecules are twisted dozens of times, since the alignment patterns 11 and 21 need to be disposed to correspond to the ULH mode liquid crystal 300 which is aligned in a vertical direction to the first and second substrates 110 and 210, a distance between the alignment patterns 11 and 21 may be provided to correspond to a pitch or be n multiples of one pitch in the spiral structure of the ULH mode liquid crystal 300. Further, the alignment patterns 11 and 21 and the alignment grooves 12 and 22 are disposed on the upper and lower panels 100 and 200, respectively, and each of the alignment patterns 11 and 21 and the alignment grooves 12 and 22 disposed on inner surfaces of the lower panel 100 and the upper panel 200 may be provided at a corresponding position.

Accordingly, the distance between the alignment patterns 11 and 21 may be provided as about 200 nanometers (nm) to about 4,000 nm, and preferably about 200 nm to about 300 nm.

The alignment patterns 11 and 21 may be defined in any direction of the horizontal direction or the vertical direction in the plan view of FIG. 1.

Polarizers (not illustrated) are provided on outer sides of the panels 100 and 200, and polarization axes of the two polarizers are parallel or perpendicular to each other. In the case of a reflective LCD device, one of the two polarizers may be omitted.

Next, a manufacturing method of the alignment patterns 11 and 21 according to an exemplary embodiment of the invention will be described in detail with reference to FIGS. 8 to 12.

FIGS. 8 to 12 are cross-sectional views sequentially illustrating a manufacturing method of an alignment pattern according to an exemplary embodiment of the invention.

First, referring to FIG. 8, an organic layer 189 is disposed on the upper side of the lower panel 100, and a photoresist 400 is additionally disposed on the organic layer 189. In an exemplary embodiment, the organic layer 189 may include the same material as the photoresist PR 400, and the organic layer 189 may be omitted.

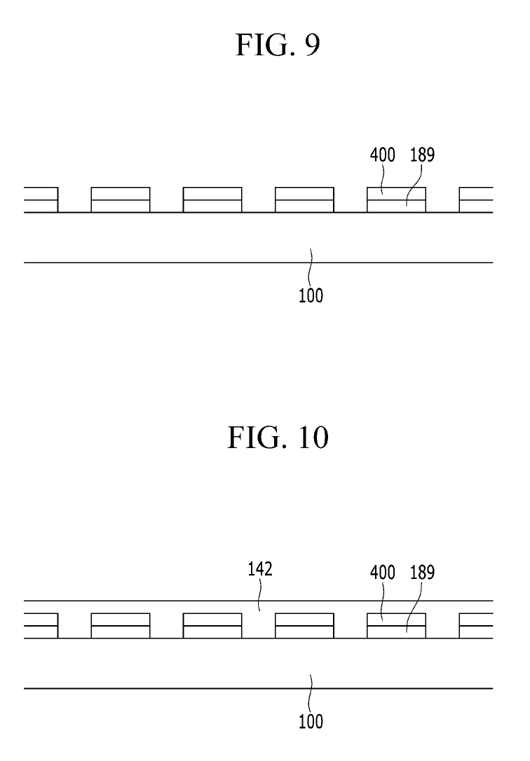

Referring to FIG. 9, a pattern is provided by exposing and developing the organic layer 189 disposed on the upper side of the lower panel 100 and the photoresist 400 disposed on the organic layer 189.

As illustrated in FIG. 10, a pattern layer 142 including silicon oxide (SiOx) or silicon nitride (SiNx) is disposed on the entire surface including an upper portion of the organic layers 189 and the photoresists 400 and grooves of the defined patterns.

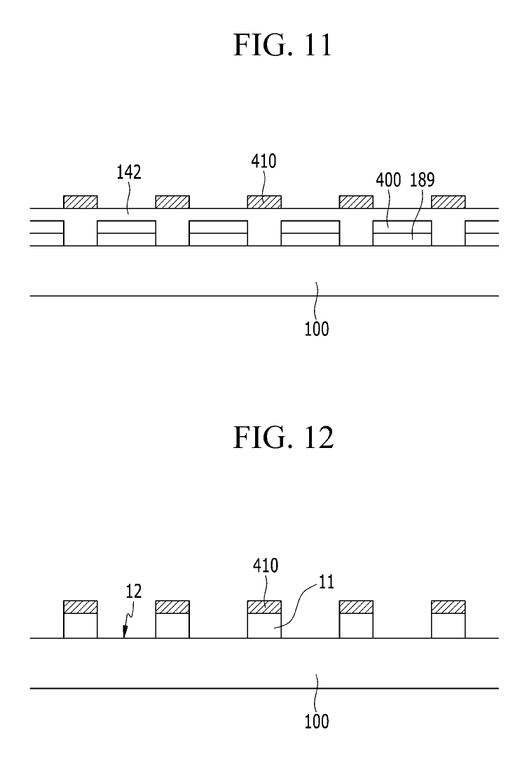

Next, as illustrated in FIGS. 11 and 12, after an etching pattern 410 is provided by using a metal and the like at a portion where the organic layer 189 and the photoresist 400 are not provided, the alignment pattern 11 is provided by etching all of the pattern layer 142 of the portion where the organic layer 189 and the photoresist 400 are provided, the organic layer 189, and the photoresist 400.

Thereafter, the alignment pattern 11 illustrated in FIG. 7 is completed by removing the etching pattern 410 remaining on the alignment pattern 11.

The alignment pattern 21 of the upper panel 200 may be also provided by the same process as the process of manufacturing the alignment pattern 11 of the lower panel 100.

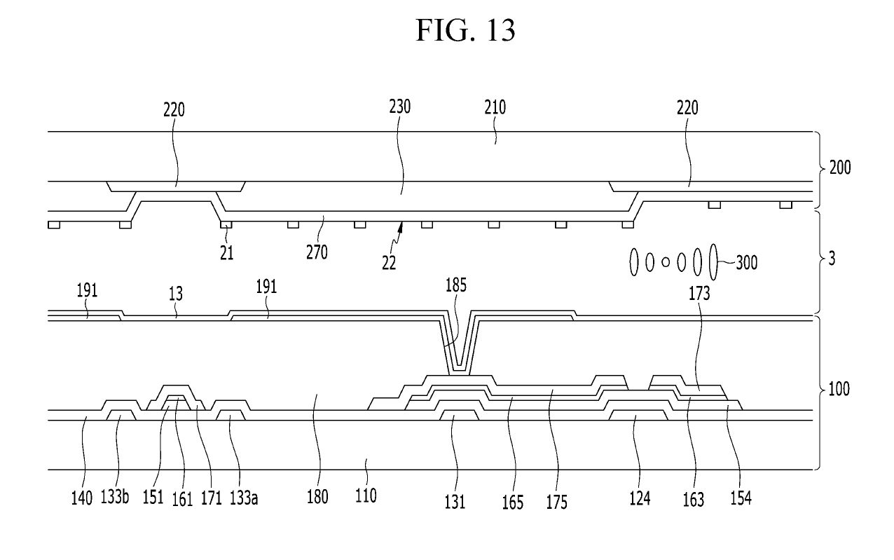

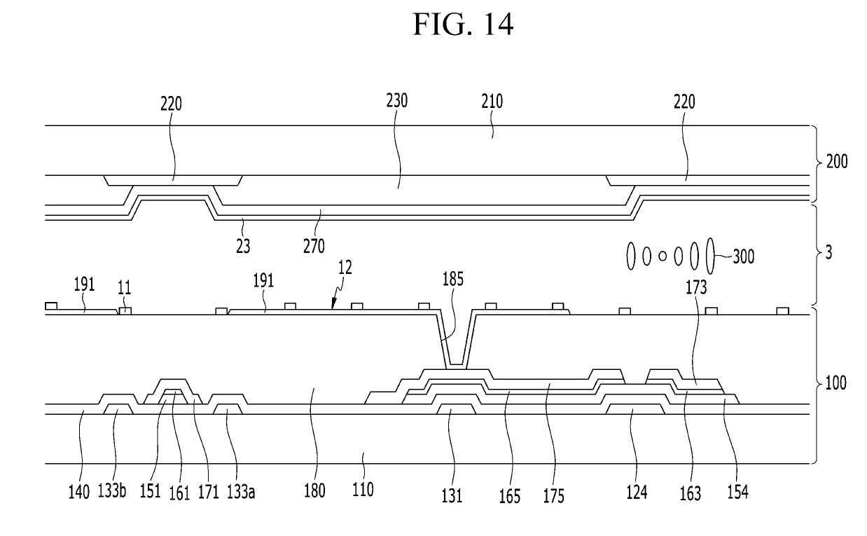

Next, an LCD device according to another exemplary embodiment of the invention will be described in detail with reference to FIGS. 13 and 14.

Another exemplary embodiment of the invention illustrated in FIGS. 13 and 14 are substantially the same as the exemplary embodiment illustrated in FIGS. 1 to 3, except for only the alignment pattern, and the duplicated description is omitted.

As illustrated in FIG. 13, the alignment pattern 21 of the LCD device according to another exemplary embodiment of the invention is disposed only on the inner side of the upper panel 200, and the alignment layer 13 may be disposed on the inner side of the lower panel 100, and the alignment layer 13 of the lower panel 100 may be a horizontal alignment layer or a vertical alignment layer.

Further, as illustrated in FIG. 14, an alignment pattern 11 of the LCD device according to yet another exemplary embodiment of the invention may be disposed only on the inner side of the lower panel 100, and in this case, the alignment layer 23 may be disposed on the inner side of the upper panel 200, and the alignment layer 23 of the upper panel 200 may be a horizontal alignment layer or a vertical alignment layer.

According to the exemplary embodiment of the invention, there are advantages of simply manufacturing and stabilizing the alignment of the ULH mode liquid crystal without a separate process by using the alignment pattern instead of the alignment layer, and having excellent liquid crystal heat stability through uniform arrangement of the liquid crystal.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display device, comprising:
a first substrate;
a second substrate facing the first substrate;
a pair of field generating electrodes respectively disposed on the first substrate and the second substrate;
an alignment pattern disposed on an inner side of any one of the first substrate and the second substrate; and
a liquid crystal layer disposed between the first substrate and the second substrate and including a liquid crystal disposed in a spiral structure in which chiral nematic liquid crystal molecules are repetitively twisted at a predetermined pitch with reference to a spiral axis which is vertical to a progress direction of light in a voltage-off state,
wherein the alignment pattern is defined in a protruding shape to correspond to the predetermined pitch.

2. The liquid crystal display device of claim 1, wherein:
the liquid crystal is optically isotropic in the voltage-off state, and
birefringence is generated in a voltage applying direction in a voltage-on state.

3. The liquid crystal display device of claim 1, wherein:
a plurality of alignment patterns is provided, and
an alignment groove is defined between adjacent alignment patterns of the plurality of alignment patterns.

4. The liquid crystal display device of claim 3, wherein:
the alignment pattern includes silicon oxide (SiOx) or silicon nitride (SiNx).

5. The liquid crystal display device of claim 4, wherein:
a distance between the adjacent alignment patterns corresponds to a multiple of the predetermined pitch of the liquid crystal disposed in the spiral structure.

6. The liquid crystal display device of claim 5, wherein:
the alignment pattern corresponds to a portion where the liquid crystal is arranged in a vertical direction to the sides of the first substrate and the second substrate.

7. The liquid crystal display device of claim 5, wherein:
a distance between the adjacent alignment patterns is about 200 nanometers to about 4,000 nanometers.

8. The liquid crystal display device of claim 5, wherein:
a distance between the adjacent alignment patterns is the same as the predetermined pitch of the liquid crystal disposed in the spiral structure.

9. The liquid crystal display device of claim 8, wherein:
a distance between the adjacent alignment patterns is about 200 nanometers to about 300 nanometers.

10. The liquid crystal display device of claim 1, wherein:
the alignment pattern are disposed on all of inner sides of the first substrate and the second substrate.

11. The liquid crystal display device of claim 10, wherein:
the alignment pattern disposed on the inner sides of the first substrate and the second substrate is provided at a corresponding position.

12. A manufacturing method of a liquid crystal display device, comprising:
forming a pixel electrode on a first substrate;
sequentially depositing an organic layer and a photoresist on the first substrate provided with the pixel electrode;
forming a pattern defined in a straight line by exposing and developing the organic layer and the photoresist;
forming a pattern layer on the entire surface of the first substrate, including on an upper portion of the patterns of the organic layers and the photoresists and grooves defined between the patterns;
forming an alignment pattern and an alignment groove which protrude from the first substrate by etching portions corresponding to the patterns of the organic layers and the photoresists in the pattern layer;
forming a common electrode on a second substrate facing the first substrate; and
injecting a liquid crystal disposed in a spiral structure in which chiral nematic liquid crystal molecules are repetitively twisted at a predetermined pitch with reference to a spiral axis which is vertical to a progress direction of light in a voltage-off state, between the first substrate and the second substrate.

13. The manufacturing method of claim 12, wherein:
the alignment pattern includes silicon oxide (SiOx) or silicon nitride (SiNx).

14. The manufacturing method of claim 13, wherein:
a plurality of alignment patterns is provided, and
a distance between adjacent alignment patterns corresponds to a multiple of one pitch of the liquid crystal disposed in the spiral structure.

15. The manufacturing method of claim 14, wherein:
the alignment pattern corresponds to a portion where the liquid crystal is arranged in a vertical direction to the sides of the first substrate and the second substrate.

16. The manufacturing method of claim 15, wherein:
a distance between the adjacent alignment patterns is the same as one pitch of the liquid crystal disposed in the spiral structure.

17. The manufacturing method of claim 16, wherein:
a distance between the adjacent alignment patterns is about 200 nanometers to about 300 nanometers.

18. The manufacturing method of claim 12, further comprising:
forming an alignment pattern on an inner side of the second substrate by the same method as the same method as the alignment pattern formed on the first substrate.

19. The manufacturing method of claim 18, wherein:
the alignment patterns disposed on the inner sides of the first substrate and the second substrate are disposed at a corresponding position.
